(19) United States
(12) Patent Application Publication
(10) Pub. No.: US 2011/0042280 A1
(43) Pub. Date: Feb. 24, 2011

(54) Bag Path Fluid Filter Assembly

(75) Inventors: Terry L. Lautzenheiser, Nunica, MI (US); Liane B. Hopaluk, Lowell, MI (US); Michael E. Miles, Grand Rapids, MI (US)

Correspondence Address: ALTICOR INC., 7575 FULTON STREET EAST MAILCODE 78-2M, ADA, MI, 49355, US

(73) Assignee: ACCESS BUSINESS GROUP INTERNATIONAL LLC, Ada, MI (US)

(21) Appl. No.: 12/543,906

(22) Filed: Aug. 19, 2009

(51) Int. Cl. B01D 29/60; B01D 29/11

(52) U.S. Cl. 210/88; 210/446; 210/143

(57) ABSTRACT

A fluid filter assembly including a flexible and formable enclosure so as to be useable in many filter applications. The enclosure defines a portion of a fluid flow path residing entirely within the filter assembly, eliminating any fluid contact within the remaining portions of the filter assembly. This flow path is advantageous to reduce the possibility of contamination and to ease in cleaning and maintenance of a device utilizing the filter assembly. The enclosure may be formed of UV-transparent material to allow for UV treatment of fluid passing though the filter assembly. Electronic controls may be combined with the filter assembly to control and monitor fluid flow. Check valves or other closure devices also may be included with the filter assembly to facilitate easy filter changes.

### BACKGROUND

The present invention relates to filters and more particularly to filters for potable water filtration systems.

Fluids are rarely found in nature in a pure state. It is more likely that any fluid has some level of contamination, which may make it undesirable for its intended purpose. There are various methods and apparatuses for removing contaminants from fluids. For example, fluids can be distilled and the condensed vapor resulting in a purified fluid. Another approach is the use of a particulate filter to capture contaminants suspended in the fluid as it flows through the filter.

Water is a fluid that is essential for human life. In many cases, however, naturally occurring water is non-potable (unfit for drinking) due to contaminants contained in the water. Many of these contaminants are particulates, and some are microorganisms. Particulates are easily captured by filters, and UV light is commonly used to deactivate microorganisms.

In many places around the world, water is delivered to customers for consumption in homes, business, and public places. In other situations, water is drawn from local wells, streams, lakes, and other water sources. Naturally, the quality of the water varies widely, even from one municipal system to another, let alone an open body of water. Whether consumers pay for treated water from a municipality, or obtain their water for free from other sources, there is a strong desire for additional water treatment, especially water treatment using filters and UV light exposure.

Water treatment systems, or devices generally consist of a water inlet, a filtering area, a water outlet, and optionally an ultraviolet (UV) light source exposure area for destroying living microorganisms. In many instances, water enters a treatment device and travels a circuitous route within that device before exiting. As a result, water contacts many interior surfaces within such a treatment device. Any surface that drinking water touches must pass a rigorous set of standards to insure that the surface does not contaminate the water. For example, a surface may contain oils from the manufacturing process that could leach into the water being treated. Also, some materials which may be good selections from an engineering standpoint have additional issues that make their use in a water treatment device undesirable, such as aluminum. Aside from defeating the purpose of using a water filter device, removing any contaminants from water-exposed surfaces greatly increases manufacturing cost and overall complexity.

Water filter elements, commonly referred to as “filters”, are installed downstream of the water inlet of a treatment device. Filters are generally composed of carbon, various synthetic fibers, or filter membranes. Generally, a compartment is set aside within the device to house the filter, allowing for easy access when the filter is to be replaced. The user/operator of the treatment device may replace the filter manually in order to maintain the intended performance of the device.

Many water filters include a rigid housing, with an internal filtering element designed to trap particles of various sizes. These filters often include components formed of plastic resins. Molding tools for making these filters are expensive, and may require a sizeable production run to be economically viable. Making changes to the treatment device likely results in changes to the filter and may be costly and preferably are avoided.

### SUMMARY

The aforementioned issues are addressed in the present invention in which the water flow path is constructed of one continuous plastic (such as PTFE) film sleeve, extending through the treatment device, and including a filter element at some point, enhancing the integrity of the water flow path.

In a current embodiment, a film sleeve begins at the water point of entry into the device, whereupon a connection or port would be secured to the front of the sleeve, to provide a watertight seal with the water supply line. Next, the film extends into the device, around and through various internal components, such as a UV light source, before entering the section of the film sleeve containing the filter element. Downstream of the filter element, the film sleeve makes its way through the device until the exit, whereupon the sleeve is terminated with a connection or port using a watertight seal, as used in the entry port. This flow path according to this embodiment also avoids exposing the water to any surface or material within the device, and additionally eliminates any leakage from seals, gaskets, or other means of maintaining water tightness within the device. An added benefit of this embodiment pertains to ease of maintenance and improved serviceability. When the filter element is to be replaced, the user opens the device and removes the entire flow path—the sleeve and the filter element together as a unit—and installs an entirely new flow path with integrated filter element. The result of which is a completely new, water flow path which contrasts with other treatment devices using seals, gaskets or the like which age over time, become brittle, and generally lose their ability to seal, resulting in water leakage.

Alternatively, a flow path using the film sleeve may have a segmented approach. The flow path through the treatment device includes several segments. For example, one segment begins at the entry connection port, where a watertight seal secures the connection to the film sleeve. The sleeve then enters the device and arrives at the filter element, contained in a film sleeve section. Another watertight connection port is secured to the film sleeve to allow the filter element sleeve segment to be detached for replacement. On the other side of the filter element sleeve section is another connection port for connecting to the downstream film sleeve section. A watertight connection secures the film sleeve to the water dispensing line. In this approach, the film sleeve has several segments connected using sonic welding or other plastic-to-plastic joining techniques common in the art. The filter element can then be replaced while the remaining film sleeve sections stay within the device.

The present invention reduces the number of joints requiring watertight seals, or in some instances eliminates them altogether.

As further disclosed, the present invention includes a bag path fluid filter assembly that is the direct fluid water flow path for a water treatment device, and which is made of a plastic formable material, at least some portion of which is UV-permeable, has at least one inlet and outlet flow port connection for water entry and exit, contains a filter element for capturing particles, is optionally equipable with a UV light source and control unit with display, optionally has a flow detector measuring device, and is capable of withstanding varied levels of water pressure. The bag path fluid filter assembly reduces production and material costs, is easier and faster to manufacture, and provides for easy device maintenance.

The present invention optionally includes a flow detector turbine within the flow path.

In at least one embodiment, the plastic film sleeve is preferably made of at least one piece of formable material, such as polytetrafluoroethylene (PTFE), but may be constructed of other plastic materials now known or as may become available or offer physical characteristics which are applicable to film sleeve construction.

In at least one embodiment, the plastic film sleeve material is UV-light permeable, allowing for UV light to permeate the film sleeve to deactivate microorganisms that may be in the fluid flow path. Additionally, the film sleeve material withstands the UV light exposure without degradation. This embodiment isolates the water within the film sleeve that is UV permeable and can withstand the affects of UV light.

In another embodiment, check valves are added to each inlet and outlet connection port to prevent water from escaping and contaminants from entering during filter changes or other maintenance and assembly.

In another embodiment, water flow paths are added to the bag path fluid filter enclosure to accommodate a UV light source. The enclosure with flow paths is made of a material that allows UV light to pass through without degrading the enclosure material. Electronic controls with display are optionally located on enclosure surface, so as to control and measure the UV light source output, water flow, and other parameters.

In another embodiment, the bag path fluid filter assembly contains a filter element, a water flow detector or measurement device, such as a turbine, and is sealed along with a reinforcing sealing band. Water flow fittings are located on the filter element enclosure. One fluid flow path on the enclosure includes a UV light source exposure area and a UV light source (e.g., in a circular or annular bulb shape). Near the UV light source area are located the electronic controls, including an optional user display. A UV transparent pressure window in the UV light exposure area optionally provides additional strength to the water flow area for high water pressure installations and situations while still allowing UV light to contact the water to be treated.

For a better understanding, together with other and further features and advantages thereof, reference is made to the following description, taken in conjunction with the accompanying drawings.

It will be readily understood that the components of the present disclosure, as generally described and illustrated in the figures herein, may be arranged and designed in a wide variety of different configurations. Thus, the following more detailed description of the embodiments of the apparatus, system, and method of the present disclosure, as represented in FIGS. 1 through 16, is not intended to limit the scope, as claimed, but is merely representative of selected embodiments.

Reference throughout this specification to “one embodiment” or “an embodiment” (or similar) means that a particular feature, structure, or characteristic described in connection with the embodiment is included in at least one embodiment thus described. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous details are provided, such as examples of bag path fluid filters, etc., to provide a thorough understanding of the embodiments. One skilled in the art will recognize, however, that the disclosure can be practiced without one or more of the specific details, or with other methods, components, materials, etc. In other instances, well-known structures, materials, or operations are not shown or described in detail to avoid obscuring aspects of the disclosure.

The illustrated embodiments of the disclosure will be best understood by reference to the drawings, wherein like parts are designated by like numerals or other labels throughout. The following description is intended only by way of example, and simply illustrates certain selected embodiments of devices, systems, and processes that are consistent with the disclosure as claimed herein.

### BRIEF DESCRIPTION OF THE DRAWINGS

FIG. 1 is a cutaway view of one embodiment.

FIG. 2 is another cutaway view of one embodiment.

FIG. 3 is an exploded view of one embodiment.

FIG. 4 is a cross-sectional view of one embodiment.

FIG. 5 is a perspective view of one embodiment.

FIG. 6 is a perspective view of one embodiment.

FIG. 7 is a cross-sectional view of one embodiment.

FIG. 8 is a cross-sectional view of one embodiment.

FIG. 9 is a perspective view of one embodiment.

FIG. 10 is a cross-sectional view of one embodiment.

FIG. 11 is a cross-sectional view of one embodiment.

FIG. 12 is an exploded view and complete assembly view of one embodiment.

FIG. 13 is an exploded view and complete assembly view of one embodiment.

FIG. 14 is an exploded view and complete assembly view of one embodiment.

FIG. 15 is a cross-sectional view of one embodiment.

FIG. 16 is a cross-sectional view of one embodiment.

### DETAILED DESCRIPTION

In the present specification, specific embodiments are described. However, one of ordinary skill in the art will appreciate that various modifications and changes can be made without departing from the scope as set forth in the claims. Accordingly, the specification and figures are to be regarded in an illustrative rather than a restrictive sense, and all such modifications are intended to be included within the scope of the disclosure. The benefits, advantages, solutions to problems, and any element(s) that may cause any benefit, advantage, or solution to occur or become more pronounced are not to be construed as a critical, required, or essential features or elements of any or all the claims.

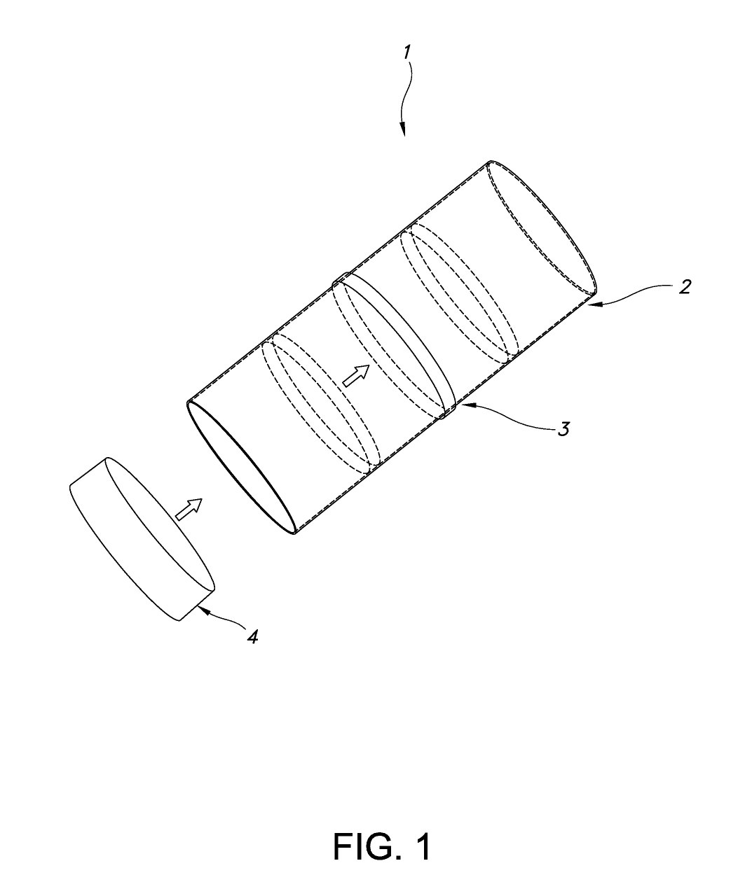

Referring now to FIG. 1, one embodiment is provided. Bag path fluid filter assembly 1 is shown. Plastic film sleeve 2 is formed by extrusion or other plastic forming techniques, to create a cylindrical or annular shape. Other shapes may be used, such as oval, as is desired. The plastic comprising the film may be any type which is formable into sheet films, preferably PTFE, but other suitable plastics may be used. PTFE is a preferred material for its inert properties and its UV properties. Once the film sleeve is formed in the desired shape, sealing band 3 is placed about the outside diameter of the sleeve 2 in the location where filter element 4 will be located. Sealing band 3 is preferably constructed of a plastic material and is secured to the film sleeve by sonic welding or other appropriate joining method. Once sealing band 3 is located and secured, filter element 4 is positioned within the film sleeve 2 such that sealing band 3 is directly in-line with the filter element 4. Sealing band 3 acts as a reinforcement and strengthening member as the fluid flows through the filter element 4.

Supply water can vary in line pressure, depending upon location and infrastructure, among other reasons. Because of this potential for pressures to be high, low, or varied, the bag path fluid filter must be able to withstand pressure within reasonable limits. Based on research and experimentation, water pressure can vary from a few pounds per square inch (psi) to as much as 120 psi (over 8 atmospheres) in some localities. Thus, the strength of the enclosure material, the sealing band, and the filter preferably are selected to withstand such pressures. The enclosure halves are fused together using traditional plastic joining techniques, such as heat welding, and the sealing band, located about the filter, is joined to the connected halves in a similar manner or other manner as appropriate. As a result, the filter is now watertight, and also importantly, the water path is restricted to the filter and not any other component of the filter device, thus reducing undesirable issues with surface contact and contamination and safety regulations.

Any contaminants are therefore substantially confined, reducing the need to clean the water path (or any other component) of the water treatment device in periodic maintenance or service. A treatment system user simply disconnects the water inlet and outlet connections, discards the exhausted filter and accompanying water path and replaces with a new filter/water path combination. Contaminants within the removed flow path remain in the removed flow path, and the cleanliness of the device is enhanced. Seals or gaskets are eliminated along the water path of the device because the assembly is the sole water path. Thus, the manufacture of a device incorporating the present disclosure can be simpler and less costly, while still providing desired levels of water purification, and can be much simpler to maintain and operate.

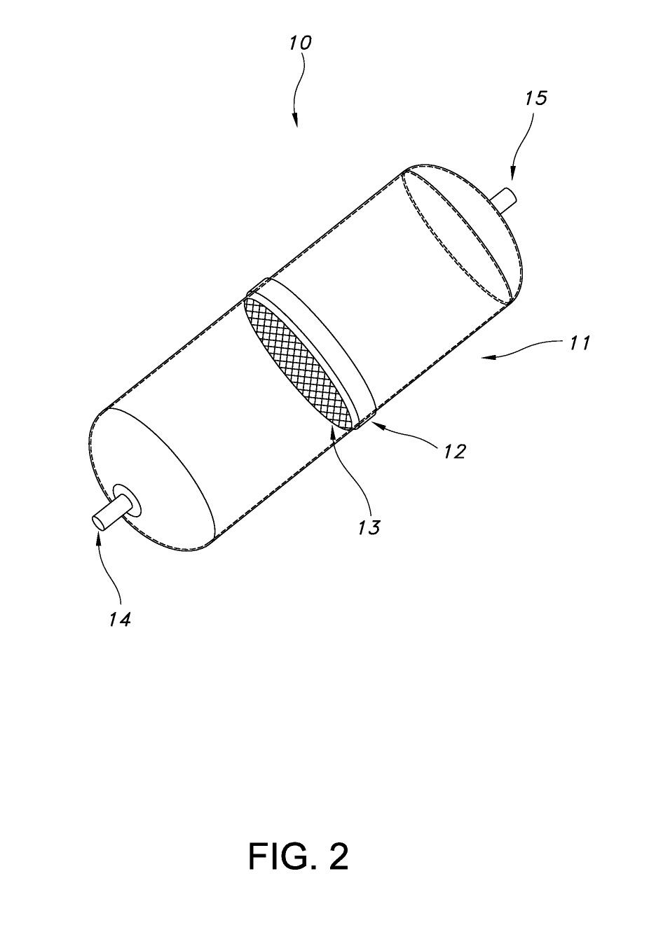

FIG. 2 illustrates the construction of another embodiment. Bag path fluid filter assembly 10 is shown. The originally open ends of film sleeve 11 are sealed about inlet/outlet ports 14 using sonic or heat welding or other appropriate plastic joining methods, such as adhesives if desired. Preferably, sonic welding or other plastic-melting type sealing is used to avoid introduction of other components to the fluid flow path. Sealing band 12 is disposed about filter 13 located within the cavity formed by film sleeve 11. Inlet and outlet ports 14 are preferably made of plastic and allow for fluid to flow into and out of the treatment device, and provide locations where fluid pipes or lines may be connected. Additionally, ports 14 may include check valves to prevent fluid from leaking out of the device during service, such as when the device is replaced with a new example (e.g., when the filter element is full).

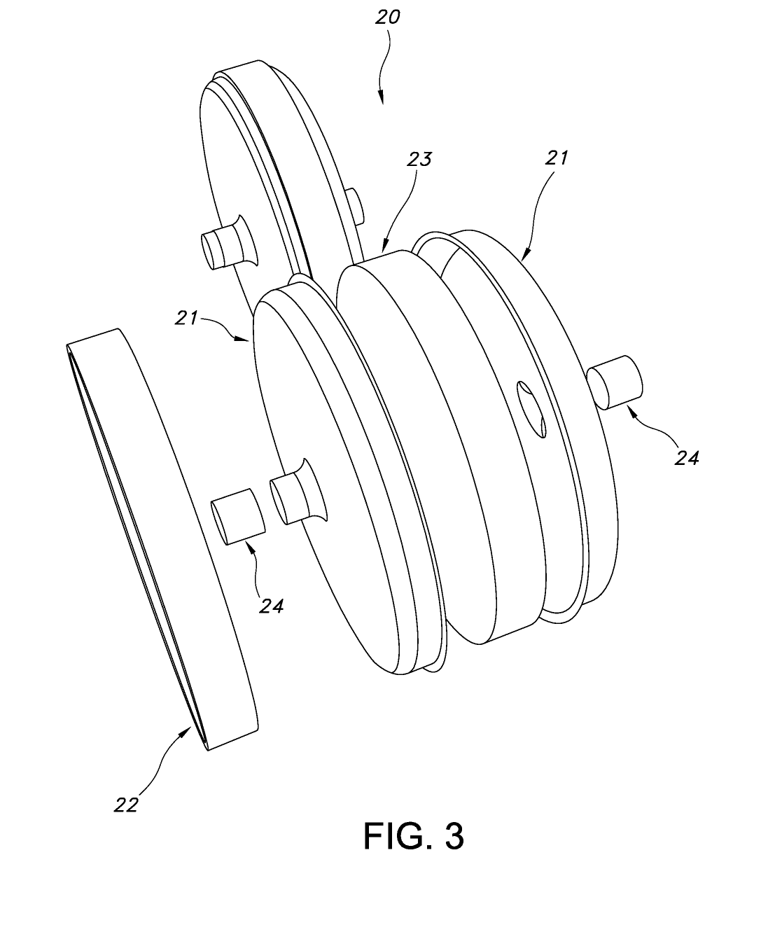

FIG. 3 illustrates another embodiment. Bag path fluid filter assembly 20 is shown complete, and in an exploded view. In this embodiment, plastic film sleeve 21 is formed in two halves, but may be formed in a plurality of portions as desired for particular applications using plastic forming methods such as pressure molding. Film sleeve halves 21 are formed so as to be adaptably joined together with sealing band 22, also made of a plastic material. Disposed within the two halves of film sleeves 21 is filter element 23 of a shape that coincides with the shape of the film sleeve so that the filter element 23 nests within the two film sleeve halves 21. Attached to either half of film sleeve 21 is an inlet or outlet port 24, which optionally may also include an integral check valve to prevent fluid from leaking out of the filter assembly 20, such as during filter replacements or other service or installation activities.

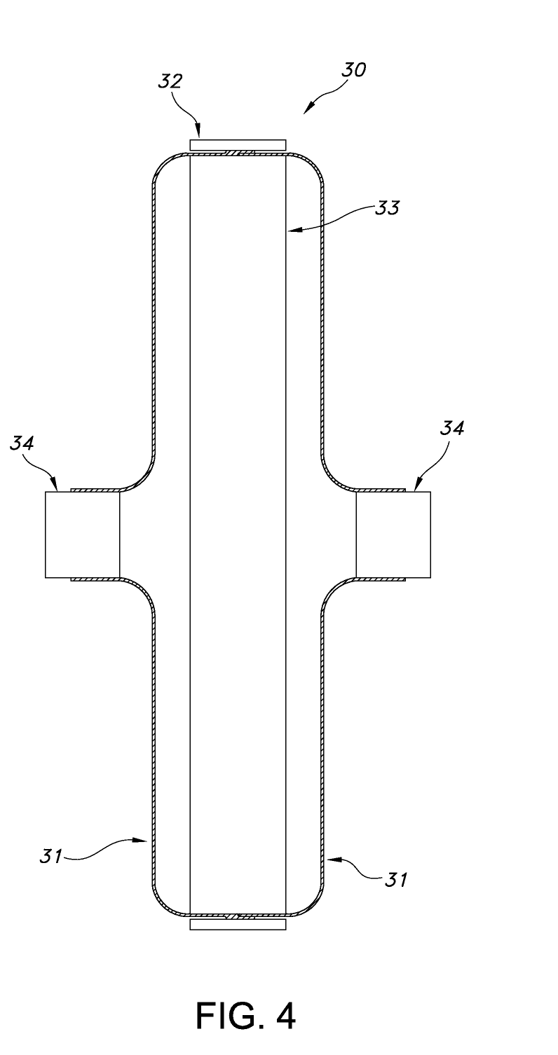

FIG. 4 is a cross-sectional view of an embodiment including a bag path fluid filter assembly 30. Plastic film sleeves 31, formed in half sections in this embodiment, are joined together by sealing band 32, enclosing filter element 33. Sleeve halves 31 and sealing band 32 are joined together to form a watertight seal, using joining methods such as sonic or heat welding or other methods appropriate for water or other fluid connections. On either half of sleeves 31 is at least one inlet/outlet ports 34, allowing fluid to enter and exit the filter assembly 30. Optionally, the ports 34 include a check valve or other quick-connect style attachment for easy installation, service, or maintenance.

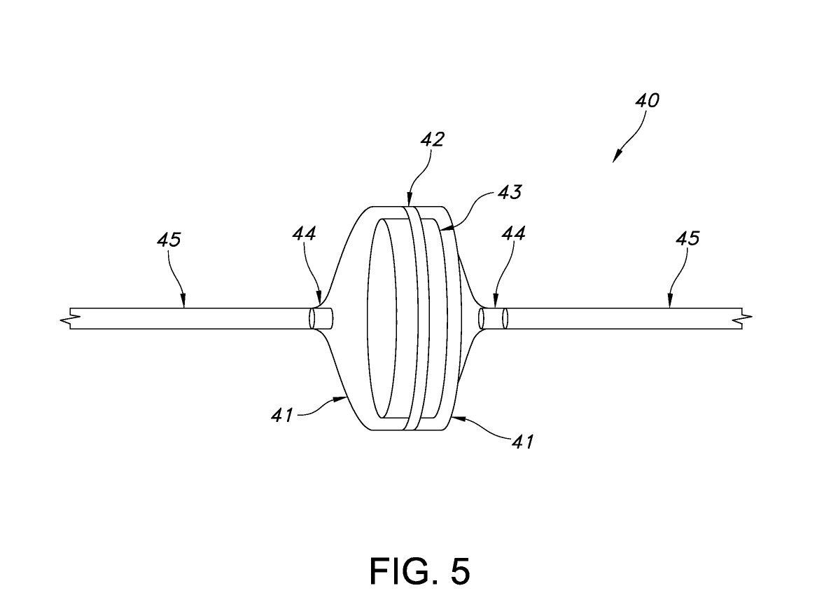

FIG. 5 illustrates another embodiment. Bag path fluid filter assembly 40 is shown, with two film sleeves 41 joined together with sealing band 42, enclosing filter element 43. Inlet/outlet ports 44 are shown attached to film sleeves 41 to provide for fluid entry and exit from the enclosed filter element 43. Fluid delivery lines 45 (inbound and outbound) are shown attached to ports 44, which transport fluid to and from the treatment device. The inbound, or supply line, may be attached to a water supply line, for example, as in a residence or restaurant. The outbound line, carrying filtered and treated water, may be attached to a dispenser faucet, cooking apparatus, or ice maker, among many possible uses.

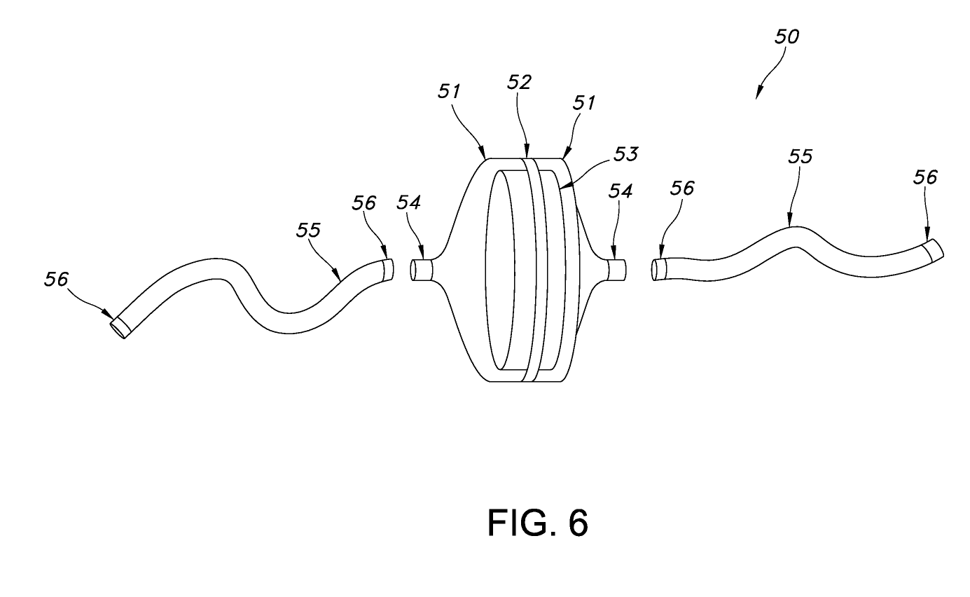

FIG. 6 is another illustration of one embodiment. Bag path fluid filter assembly 50 is shown, with two plastic film sleeve halves 51 joined together with sealing band 52. Enclosed within the cavity formed by the two sleeve halves 51 is filter element 53. At least one inlet and outlet port 54 is provided, attached to film sleeves 51. All connections are fluid and watertight, using joining methods as disclosed above. Ports 54 may optionally include check valves, quick-connects, or other connecting methods that are suitable for fluid connections and prevent leakage. Delivery lines 55 are shown, positioned to be connected to inlet/outlet ports 54. On either end of delivery lines 55 is provided another set of ports 56 that selectively engage ports 54, allowing for fluid to be delivered to the device and to be removed from it as well, after filtering and treatment. Lines 55 may be flexible, and constructed of a material which allows for flexibility while providing strength and durability, such as plastic. Optionally, lines 55 may be located within a treatment device, following the contours and routing within the device, to isolate the fluid from directly contacting the surfaces of the water treatment device. For replacement, the assembly is removed from the device, including the lines 55, and a new assembly of the present disclosure is inserted into the vacated cavity, connected to water supply and delivery (inbound and outbound) lines, and the device is then closed around the assembly disclosed herein and is ready to resume treating and dispensing water for consumption (further illustrated below).

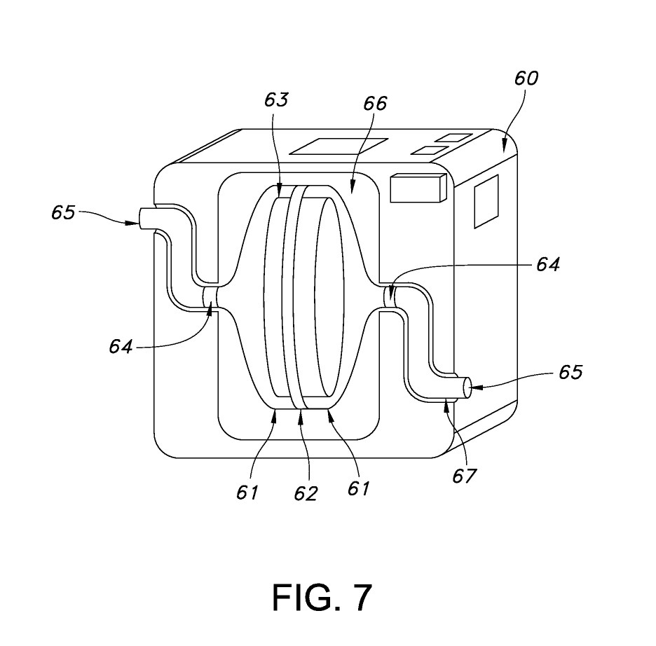

FIG. 7 illustrates another embodiment. Treatment device 60 is shown, with cavity 66. Within cavity 66 is a bag path fluid filter assembly embodiment. Film sleeves 61 joined together by sealing band 62 and enclosing filter element 63 are shown. Inlet/outlet ports 64 are connected to sleeves 61 providing for fluid entry and exit from the enclosure formed by sleeves 61. Delivery lines 65 are shown connected to ports 64. Lines 65 follow the flow path 67 within device 60, isolating the fluid and preventing it from contacting any surface of device 60 directly. Lines 65 may include connection ports of their own, for ease of installation and service, or the lines may be integral to the installation location where device 60 is located (e.g., hard-connected).

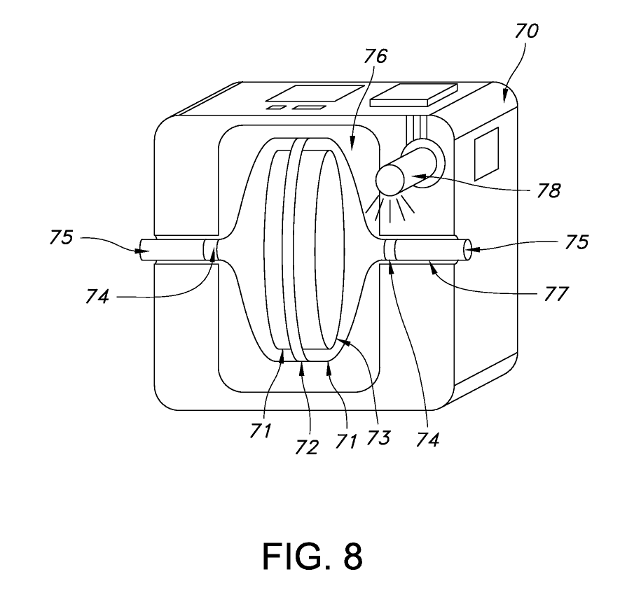

FIG. 8 illustrates another embodiment. Treatment device 70 is shown, with cavity 76. Within cavity 76 is an embodiment of the bag path fluid filter assembly. Film sleeves 71 are joined together by sealing band 72 and enclose filter element 73 as shown. Inlet/outlet ports 74 are connected to sleeves 71 providing for fluid entry and exit from the enclosure formed by sleeves 71. Delivery lines 75 are shown connected to ports 74. Lines 75 follow the flow path 77 within device 70, isolating the fluid and preventing it from contacting any surface of device 70 directly. Lines 75 may include connection ports of their own, for ease of installation and service, or the lines may be integral to the installation location where device 70 is located (e.g., hard-connected). Ultraviolet (UV) light source 78 is provided, within device 70 and along flow path 77, exposing fluid in delivery line 75 to UV radiation to deactivate microorganisms contained within.

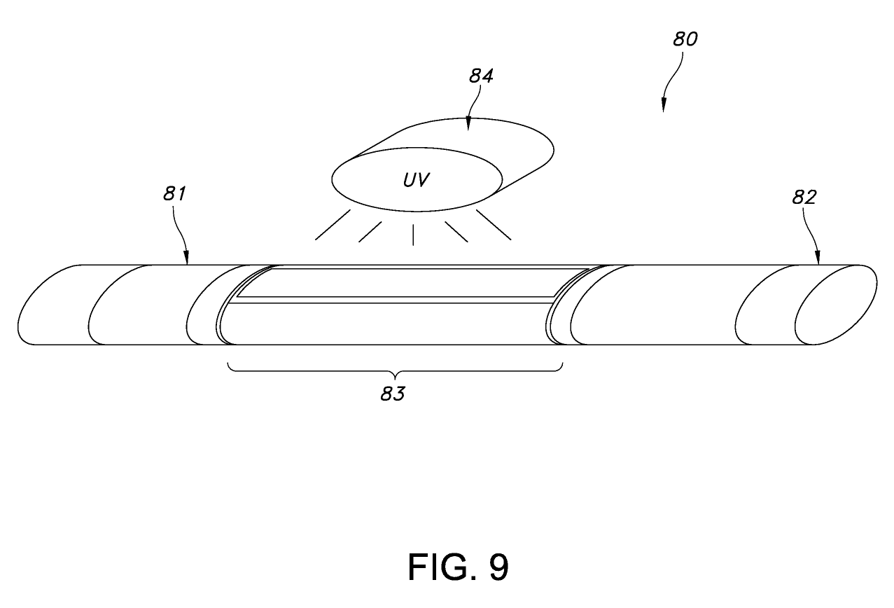

FIG. 9 illustrates another embodiment. Delivery line 80, which is connected to bag path fluid filter assembly (not shown), includes plastic film sleeve 81 (constructed identically as said assembly), inlet/outlet ports 82, and UV exposure window 83. The connection joints between sleeve 81, ports 82, and window 83 is watertight, using such methods as disclosed above. UV light source 84 emits UV light, which passes through window 83, wherein fluid passing through is irradiated, thus deactivating microorganisms contained therein. Line 80 may be installed in a treatment device flow path (not shown), isolating the fluid within from contacting the surfaces of the device.

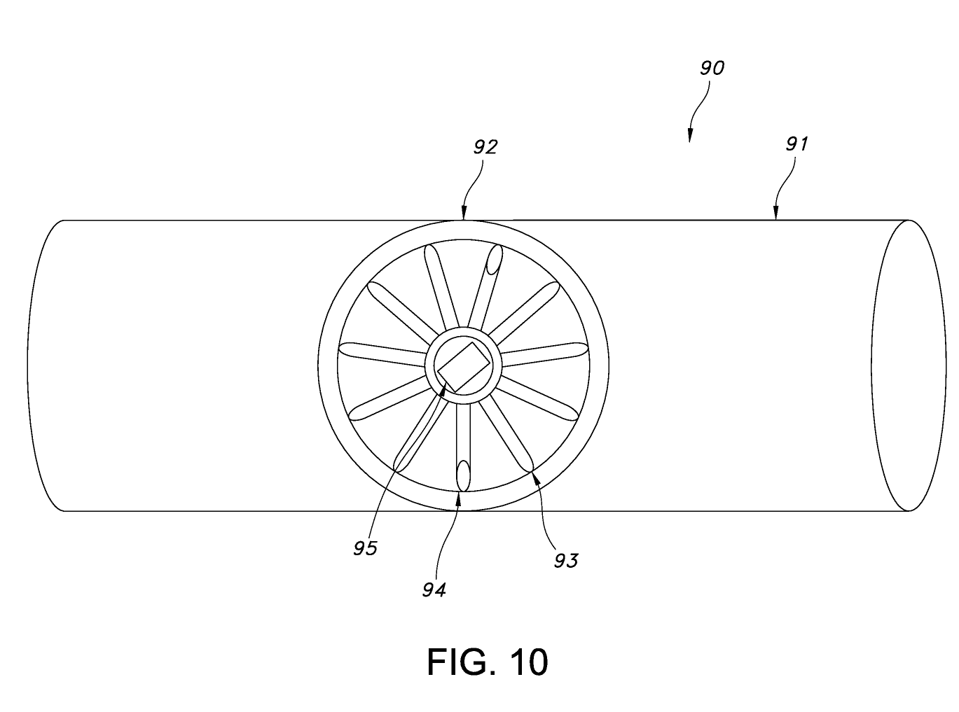

FIG. 10 illustrates another embodiment. Film sleeve 90 is shown, including delivery line 91, formed of a plastic. Flow detector 92 is located within line 91, and measures the fluid flow rate passing through line 91. The flow detector may be integrated within any portion of the device disclosed herein, either before or after the filter element, or both, to measure the rate of fluid flow. The measurement of fluid flow is useful for several reasons, such as filter life measurement, fluid pressure, and usage. Flow detector 92 includes a plurality of vanes 93, which are positioned in the fluid flow path, so as to be acted upon by the force of the fluid flowing through line 91. At least one of the vanes 93 includes a measuring device, such as a magnet 94, which allows for a measuring device (not shown) positioned outside and adjacent to line 91 to measure the flow rate electronically. Alternatively, other means for measuring rotational movement and/or velocity may be used, such as a laser, short range radio transmitter, or other rotational velocity detector as appropriate. Flow detector 92 rotates about an axle 95, which is secured to the flow detector chassis (not shown) and allows free rotation within the fluid flow.

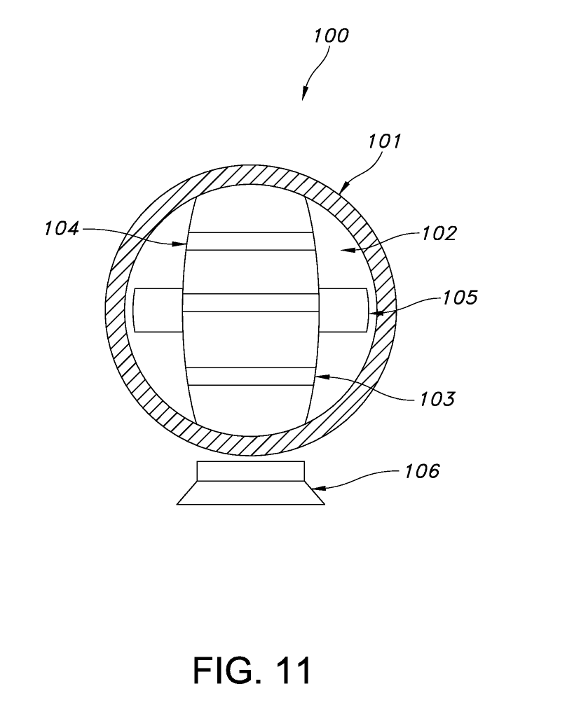

FIG. 11 illustrates another embodiment. Film sleeve 100 is shown in cross-section, including delivery line 101, formed of plastic. Flow detector 102 is positioned within line 101, such that no fluid may bypass it. The only path for fluid to follow is to flow through the vaned wheel of flow detector 102, which includes vanes 103. As disclosed previously, at least one vane 103 also includes magnet 104 attached to vane 103. The axle 105 of flow detector 102 allows for the rotation of the vaned wheel. As the wheel rotates, the magnet 104 passes by measuring device 106, located adjacent to flow detector 102 but outside delivery line 101. The passing of the magnet is detected by the device, which records, measures, and outputs the data to the treatment device (not shown). The data may be used to measure filter life, flow rate, or usage, among other relevant data that can be calculated using fluid flow information.

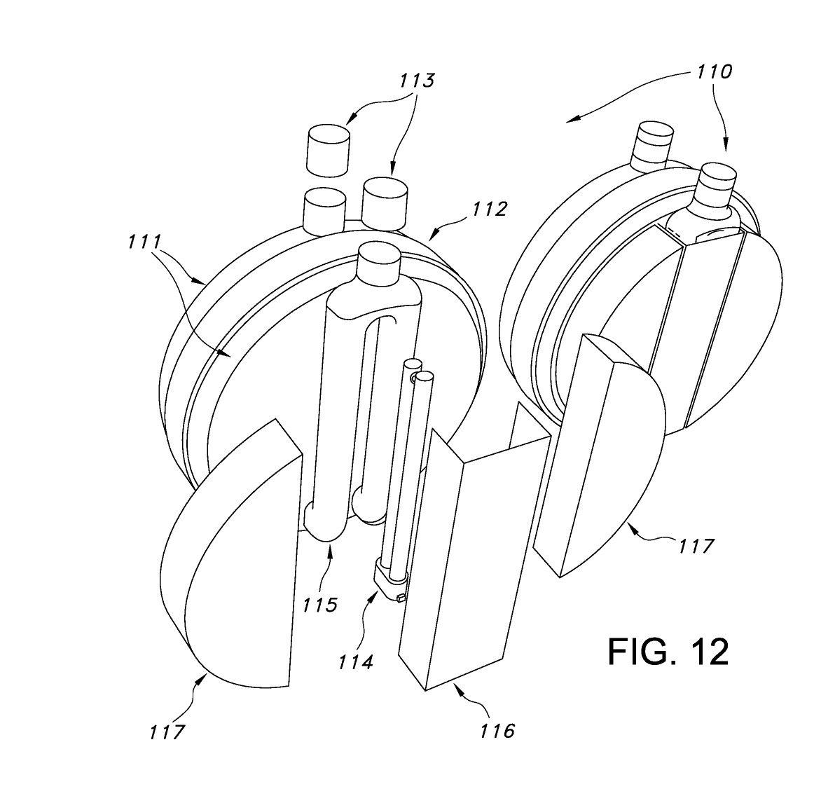

FIG. 12 illustrates a filter assembly 110 according to one embodiment. Filter element (not shown) is enclosed by the two enclosure halves 111 and securely sealed by sealing band 112. A pair of fluid fittings 113 are shown, one on either enclosure half 111 for accepting supply water and allowing treated water to exit the assembly. Ultraviolet light source 114 is disposed within a cavity formed into water flow path 115. A flow detector (not shown) may be located within flow path 115 to measure the flow rate of the treated water. Reflector 116 is disposed adjacent to UV light source 114 to reflect UV light not directed at the water to be treated, and to shield the outside environment from UV light exposure. The reflector 116 may be made of metal, such as aluminum or stainless steel, or any other suitably reflective material, such as plated plastic and is secured about the UV light source 114 using a variety of fastening means. Electronic controls 117 are located adjacent UV light source 114, and may include equipment for monitoring fluid flow rate as measured by the flow detector, and also provide additional controls and displays for operating the treatment device, such as power on/off, filter life remaining display, and other controls and displays as appropriate for a treatment device.

The embodiment shown in FIG. 12 includes UV water treatment and particulate filtering as in the previous embodiment. Incoming water enters a flow path 115, via entry port 113, and is routed through paths adjacent to the UV light source 114. As the enclosure material allows UV light to be transmitted through without degrading the PTFE material, the microorganisms that may be present in the water are deactivated. Before the water passes the UV treatment portion of the flow path, the water enters the enclosure formed by halves 111, is filtered for particulate matter by the filter (not shown), then exits the enclosure through the outlet fitting 113, and to the final dispensing location, such as a faucet or other dispenser. A reflector 116 is positioned outboard of the UV light source 114, to direct any light not originally projecting toward the enclosure and the water flow path back toward the water flow path. Additionally, the reflector prevents any UV light from escaping beyond the filter. Arranged near the UV light source 114 and reflector 116 are the control electronics 117 for the light source and the monitoring device for the flow detector turbine, if so equipped. The control electronics monitor the flow rate of the water, the UV light source, and provide additional functions such as on/off and filter life remaining. A display is located adjacent to the control electronics which provides visual and/or audio information to a user and enables the user to make selections based on desired operational modes.

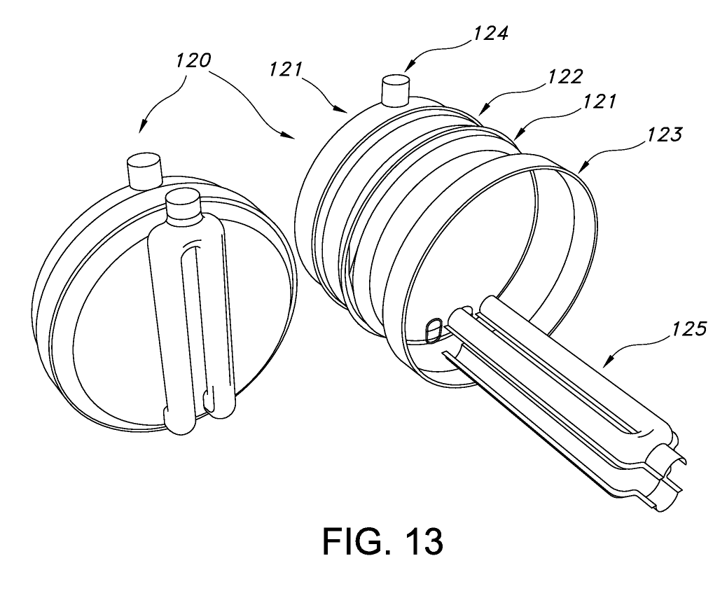

FIG. 13 illustrates one embodiment, a cutaway view of complete filter assembly 120 with filter element 122 located between enclosure halves 121 and sealing band 123. Water flow path 125 is shown in two halves prior to welding the halves, after which it is connected to a mating pair of holes in one of the halves 121 and aligned parallel to the joined halves as shown.

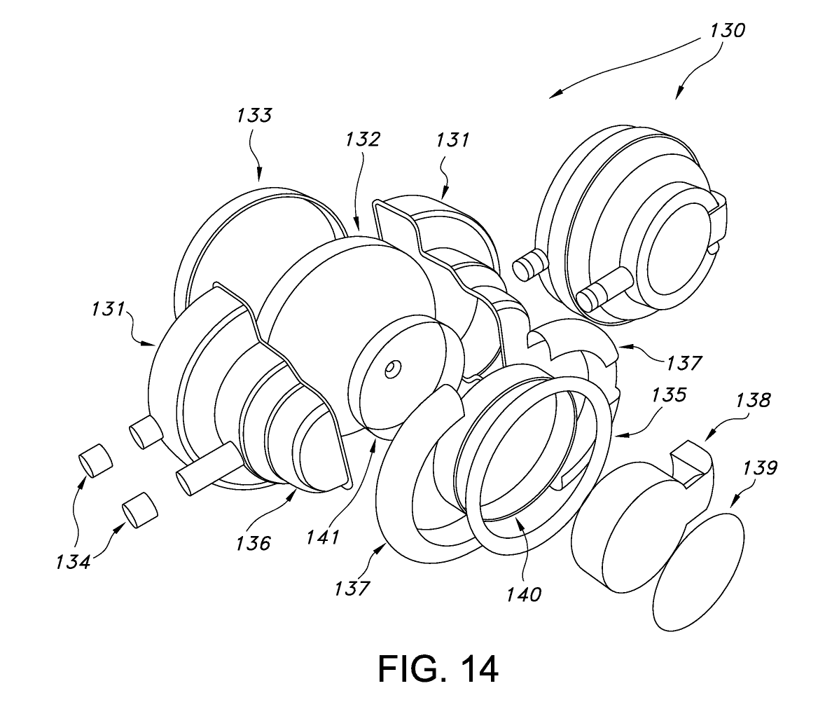

FIG. 14 illustrates another embodiment, an exploded view and assembled view of filter assembly 130 with filter element 132 and flow detector 141 enclosed by two enclosure halves 131, sealed and reinforced by sealing band 133. A pair of fluid fittings 134 are located one on each enclosure half 131. Each enclosure half 131 also includes an integrated water flow path 136. Ultra-violet light source 135 is disposed around reflectors 137 and UV-transparent pressure windows 140. Flow detector 141 measures and directs water to flow around the pressure windows 140 for UV light exposure and treatment. Controls 138 and display 139 are located within the circular cavity created by the UV light/reflector/flow detector layout for compactness in this embodiment. Controls 138 provide power to the UV light and monitor the flow rate of the fluid, filter life, and other water treatment appropriate information.

Water flows into the fluid inlet fitting of the filter, and enters the flow detector. There, the water moves through the flow detector, which causes it to spin, much like a turbine or a propeller in some embodiments. Sensors in the control electronics monitor the revolutions of the flow detector and use that information to conduct other operations, such as displaying the flow rate for the user. Water enters the filter element where particulate matter is removed. Water then moves around the flow detector and is exposed to UV light from the UV light source that surrounds the flow detector. A reflector directs wayward light back toward the UV transparent pressure window, which separates the UV light source from the water and the flow detector. Treated water then exits the enclosure through the fluid outlet fitting, to a tube attached to a dispensing unit (not shown) for consumption or other purpose by the user.

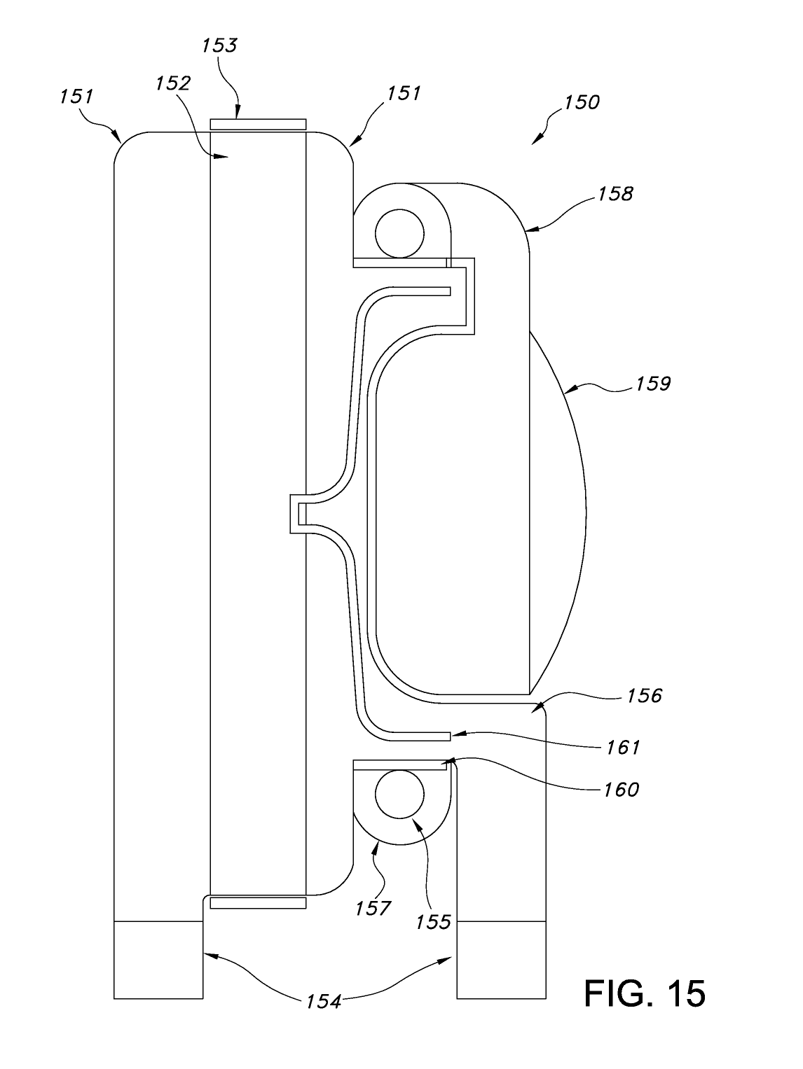

FIG. 15 is a cross-sectional view according to one embodiment. Bag path fluid filter assembly 150 is shown, with enclosure halves 151 shown banded together and reinforced by sealing band 153. Included in one half of enclosure 151 is flow detector 161. As water flows through sealed enclosure half 151, it causes the vanes, paddles, or other water engagement devices of the flow detector 161 to be disposed in the flow path 156, resulting in the rotation of the flow detector, the speed of which is monitored by electronics 158 and displayed to the user by display 159. Additionally, the flow detector insures that the water flows evenly about the UV light source 155 so that all water is exposed for proper treatment. One portion of enclosure 151 includes UV transparent pressure window 160 which allows ultraviolet light from light source 155 to pass through it and treat the water as it flows through the filter 152. Light from light source 155 is reflected by reflector 157 located outboard of UV light source 155, so as to directed light received from light source 155 back toward UV transparent window 160 and then into the water passing through the UV treatment section. Water enters and exits the assembly through flow ports 154.

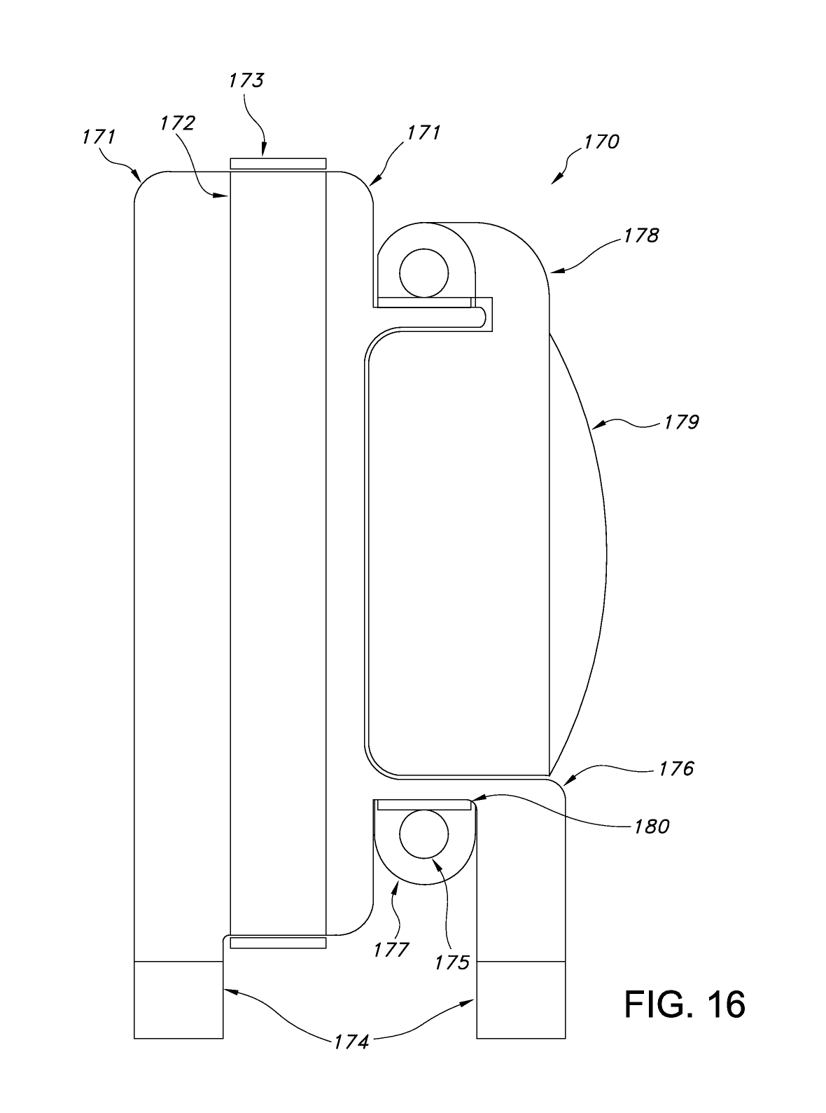

FIG. 16 is a cross-sectional view according to one embodiment. Assembly 170 is shown, with enclosure halves 171, enclosing filter element 172, sealed together and reinforced with sealing band 173. Water fittings or ports 174 are shown connected to enclosure halves 171, with at least one for water intake and at least one for water outtake. UV light source 175 is of an annular type in this embodiment, and is shown adjacent to fluid flow path 176. Fluid path 176 also includes a plurality of UV transparent pressure windows 180. In order to enhance the UV light exposure to the fluid to be treated, reflector 177 is used to direct UV light that does not directly project into the water fluid flow path 176, back towards the flow path 176. Reflector 177 also has the additional effect of shielding UV light from escaping the assembly 170. Electronic controls 178 are located adjacent to UV light source 175 along with display 179 which enables a user to operate and monitor the assembly.

Although illustrative embodiments of the present disclosure have been described herein with reference to the accompanying drawings, it is to be understood that the disclosure is not limited to those precise embodiments, and that various other changes and modifications may be effected therein by one skilled in the art without departing from the scope or spirit of the disclosure.

What is claimed is:

1. A fluid filter assembly comprising:
a sleeve including a filter enclosure portion, the sleeve having opposite ends;
at least one inlet port and one outlet port sealably connected to and located at the opposite ends of said enclosure portion; and
a filter element within the enclosure portion and having a periphery engaging said enclosure portion.

2. The fluid filter assembly of claim 1, further comprising a sealing band about the sleeve, the sealing band sealing the sleeve against the filter periphery and strengthening said enclosure portion against fluid pressure.

3. The fluid filter assembly of claim 1, wherein said filter enclosure portion comprises a plurality of sub-portions, sealably connected to each other.

4. The fluid filter assembly of claim 1, wherein said enclosure portion and said sealing band are made of plastic.

5. The fluid filter assembly of claim 1, wherein said enclosure portion and said sealing band are made of formable material.

6. The fluid filter assembly of claim 1, wherein said assembly further comprises a UV light source and a reflector.

7. The fluid filter assembly of claim 1, wherein said at least one inlet and outlet ports include closure devices.

8. The fluid filter assembly of claim 1, wherein said enclosure portion and said sealing band are selectively connected to each other.

9. The fluid filter assembly of claim 1, wherein said enclosure portion is made of UV-permeable material.

10. The fluid filter assembly of claim 1, wherein said enclosure portion includes a plurality of fluid connections adapted to allow fluid to enter and exit said enclosure portion.

11. The fluid filter assembly of claim 1, further comprising a fluid flow measurement device for measuring fluid flow.

12. The fluid filter assembly of claim 1, further comprising an electronic control unit and a display.

13. The fluid filter assembly of claim 1, wherein the flow of said fluid is measured by electronic means for determining flow velocity.

14. A bag path fluid filter assembly comprising:
at least one filter enclosure portion formed of a sleeve;
a plurality of fluid flow ports fluidly connected to said at least one enclosure portion having an inner surface;
a filter element disposably located within the enclosure portion such that said filter element contacts the inner surface of said enclosure portion;
a sealing band for selectively sealing and strengthening said at least one enclosure portion against fluid pressure;
a UV light source;
an electronic control unit and display;
a reflector for said UV light source;
a UV transparent pressure window;
and
a flow measuring device for measuring fluid flow.

15. The fluid filter assembly of claim 14, wherein said at least one filter enclosure portion further comprises a plurality of enclosure sub-portions, selectively sealably engagable to each other.

16. The fluid filter assembly of claim 14, wherein said at least one enclosure portion and said sealing band are made of plastic.

17. The fluid filter assembly of claim 14, wherein said at least one enclosure portion and said sealing band are made of formable material.

18. The fluid filter assembly of claim 14, wherein said at least one inlet port and said at least one outlet port include closure devices.

19. The fluid filter assembly of claim 14, wherein said at least one enclosure portion and said sealing band are selectively connected to each other.

20. The fluid filter assembly of claim 14, wherein at least one of said at least one enclosure portion and said sealing band are made of UV-permeable material.

21. The fluid filter assembly of claim 14, wherein said flow measurement device uses electronic means for determining flow velocity.
